(19) United States
(12) Patent Application Publication
(10) Pub. No.: US 2008/0285926 A1
(43) Pub. Date: Nov. 20, 2008

(54) Optical Fiber Having Desired Waveguide Parameters and Method for Producing the Same

(75) Inventor: Manas Ranjan Sahu, Orissa (IN)

Correspondence Address: LOWE HAUPTMAN HAM & BERNER, Suite 310, Diagonal Road, Alexandria, VA, 22314, US

(73) Assignee: STERLITE OPTICAL TECHNOLOGIES LTD., Aurangabad (IN)

(21) Appl. No.: 11/596,164

(22) PCT Filed: Mar. 7, 2006
(86) PCT No.: PCT/IN06/00079

§ 371 Date: Nov. 9, 2006

(51) Int. Cl. G02B 6/02; G01N 23/00

(52) U.S. Cl. 385/123; 65/378

(57) ABSTRACT

A method for producing an optical fiber having desired cutoff wavelength, mode field diameter [MFD] and zero dispersion wavelength [ZDW] waveguide parameters even when actual refractive index [RI] profile has various configurations is provided. The method comprises overcladding/clad jacketing over the core rod based on predetermined core diameter of the core rod; refractive index [RI] profile of core of the core rod; and refractive index [RI] profile of clad of the core rod to achieve said waveguide parameters within the predetermined limits.

### FIELD OF THE INVENTION

The present invention relates to optical fiber having desired waveguide parameters and method for producing the same. Particularly it relates to optical fiber having desired optical wave-guide parameters like cutoff wavelength, mode field diameter [MFD] and zero dispersion wavelength [ZDW] even when actual refractive index [RI] profile has various configurations.

### BACKGROUND OF THE INVENTION

Fiber-based light wave communication systems play an important role in voice and data transmission. Optical fiber for use in communication systems can be either single mode fiber or multimode fiber. Optical fiber comprises a core, to which essentially the entire signal is confined, and a clad surrounding the core. The refractive index [RI] profiles of the core and the clad, and the core diameter of the fiber determine the type of fiber.

The optical fiber is drawn from an optical fiber preform, which can be manufactured by different methods of chemical vapor deposition (CVD) in-addition to other known methods.

The optical fiber preform comprises a central core preform (herein after referred to as core rod) and an outer cladding. The core rod itself comprises a core and part of cladding of the fiber. The different methods employed in the manufacture of optical fiber preform are described in by Tingye Li in Optical Fiber Communications, Academic Press, 1985.

The overcladding/clad jacketing can be applied to the core rod by any known method. For example in an OVD method of soot deposition, the glass soot is deposited on the core rod 101 to form soot porous body (hereinafter referred to as the body), wherein the deposition is accomplished by traverse motion of the core rod over the burners as shown in accompanying FIG. 1. The deposition process continues until the required dimension of the body is attained for meeting required core diameter in fiber. The deposited porous soot is then moved into a sintering furnace, where the deposited porous soot layer is dried and consolidated in a chlorine and helium atmosphere to form a solid glass optical fiber preform at about 1500° C.

As the optical fiber is drawn from the optical fiber preform, the selection of properties at the stage of drawing the optical fiber preform can help to have an optical fiber with desired characteristics. This invention is directed to provide such method which can determine the desired waveguide properties of the optical fiber just by considering the selected properties of the optical fiber preform.

It has been observed that the waveguide fiber parameter, like cutoff wavelength, mode filed diameter [MFD] and dispersion play important role in optical signal transmission, and hence are required to be achieved in desired range.

The cutoff wavelength of optical fiber is required to be in a range varying from about 1160 nm to about 1300 nm.

The mode field diameter [MFD] of optical fiber is required to be in a range varying from about 8.9 to about 9.5 μm.

The dispersion wavelength, particularly zero dispersion wavelength [ZDW] of optical fiber is required to be in a range varying from about 1305 to about 1325 nm.

It may be noted that the above required ranges of above three waveguide parameters are vary narrow. Hence, the method to achieve these parameters during the process of manufacturing the optical fiber, that is during manufacturing the optical fiber preform from which the optical fiber having desired characteristics will be drawn should be very prefect and capable of resulting in desired parameters within the desired limits. This invention also aims at providing such method for manufacturing the optical fiber preform and to draw the optical fiber therefrom which will have said waveguide parameters, like cutoff wavelength, mold field diameter [MFD] and zero dispersion wavelength [ZDW] within the limits of the above said desired range, that is the cutoff wavelength of optical fiber is within a range varying from about 1160 nm to about 1300 nm, the mode field diameter [MFD] of optical fiber is within a range varying from about 8.9 to about 9.5 μm and the zero dispersion wavelength [ZDW] of optical fiber is within a range varying from about 1305 to about 1325 nm.

The cutoff wavelength is the wavelength above which a single-mode fiber supports and propagates only one mode of light. An optical fiber that is single-mode at a particular wavelength may have two or more modes at wavelengths lower than the cutoff wavelength. The cutoff wavelength is expressed as follows: —

λ_{c}=πdn1/V_{c}×(2Δ)̂^{0.5} equation (1)

Δ=n₁²−n₂²/2n₁² equation (2)

wherein
λ_{c} is cutoff wavelength of fiber
Δ is the ratio of refractive index [RI] difference between refractive index of core and clad and refractive index [RI] of the core of the preform
n₁ is refractive index of core of the preform
n₂ is refractive index of clad of the preform
V_{c} is normalized frequency, which is less than 2.405 for single mode optical fiber
d is diameter of the core in the fiber

The mode field diameter (MFD) describes the size of the light-carrying portion of the fiber. For single-mode fibers, this region includes the fiber core as well as a small portion of the surrounding cladding glass.

The dispersion is the time distortion of an optical signal that results from the time of flight differences of different components of that signal, typically resulting in pulse broadening. Particularly, in single mode fiber, dispersion near the operating wavelength 1310 nm at a particular wavelength will be zero dispersion and is called zero dispersion wavelength [ZDW].

The selection of desired cutoff wavelength helps to know the wavelength above which a single-mode fiber will support and propagate only one mode of light.

The selection of desired mode field diameter (MFD) helps to describe the size of the light-carrying portion of the fiber.

The selection of desired zero dispersion wavelength [ZDW] helps to estimate the time distortion of an optical signal which results from the time of flight differences of different components of that signal, typically resulting in pulse broadening.

The above three wave-guide parameters, cutoff wavelength, MFD and ZDW have been found to be functions of core diameter, and the refractive-index [RI] profiles of the core and the clad, that is have been found to be dependent on the core diameter of fiber, and the refractive index [RI] profiles of the core and the clad of the fiber. The refractive index [RI] profile of the core and the clad of the fiber is similar to the refractive index [RI] profile of the core and the clad of the optical fiber preform [comprises core rod] from which fiber is drawn. Therefore, if the core diameter of fiber, and the refractive index [RI] profiles of the core and the clad of the core rod are determined and selected accordingly, then one can have an optical fiber having these waveguide parameters within the limits of predetermined range.

It has also been surprisingly observed that determination and selection of i) refractive index profile of core of the core rod, ii) refractive profile of clad of the core rod and iii) core diameter of the fiber is not only required to have desired waveguide parameters of the fiber within the limits of predetermined range, but also required to have an optical fiber having other characteristics within the predetermined limits.

It has been further observed that the consideration of one or two of these waveguide parameters may not result in an optical fiber having these and other properties within the desired limits. Such selection is desirable only when aim is to have selected waveguide parameter within the predetermined limits.

Therefore, a method for manufacturing an optical fiber will be suitable, if it can take all the three waveguide parameters, that is cutoff wavelength, MFD and ZDW into consideration. It will be further more suitable if these parameters can be achieved within the desired range of values by considering at least i) refractive index profile of core of the core rod and ii) refractive profile of clad of the core rod.

The present invention also aims at providing such a method which will take into consideration all the three waveguide parameters, that is cutoff wavelength, MFD and ZDW and will make an attempt to provide an optical fiber having these three waveguide parameters within the desired range of above-said values and will also take into consideration at least i) refractive index profile of core of the core rod and ii) refractive profile of clad of the core rod. It will be observed from the following description of this invention that the third feature iii) desired core diameter of the fiber can be determined from the i) refractive index profile of core of the core rod and ii) refractive profile of clad of the core rod by employing above equation 2.

The U.S. Pat. No. 5,028,246 teaches that cutoff wavelength can be controlled by overcladding thickness. In accordance with this method, the core rod receives additional cladding to achieve the desired thickness required for the desired cutoff wavelength characteristics in the final drawn optical fiber. This method only teaches control of cutoff wavelength and presumes that other waveguide parameters and fiber characteristics will automatically be within the desired ranges. However, as stated herein above, it has been observed that selection of only one waveguide parameter may not result in an optical fiber having all waveguide parameters and other fiber characteristics within the predetermined limits. Accordingly, the main drawback of this method is that it does not teach how to control other waveguide parameters of the fiber, like MFD and ZWD. For example, the method taught by this patent does not consider the refractive index [RI] profiles of core and the clad, which have been observed to control the waveguide parameters of the fiber.

The Japanese patent No. JP2001-021735 teaches a method for selecting a single mode optical fiber base material only based on two parameters, that is cutoff wavelength and mode field diameter. The major drawback of this method is that it does not consider third important parameter, that is zero dispersion wavelength [ZDW]. This method presupposes that all other waveguide parameters and fiber characteristics will automatically be within the predetermined ranges if the cutoff wavelength and MFD are within the limits of predetermined ranges. However, as stated hereinabove, non-consideration of ZDW parameter may not result in optical fiber having all parameters within the desired limits.

The above Japanese method also presupposes that if an attempt is made to consider three or more parameters it will be very complicated to investigate all the parameters and to have an optical fiber having all the waveguide parameters and fiber characteristics within the predetermined ranges. On the contrary, in the present invention, it has been surprisingly observed that consideration and selection of all the three waveguide parameters, that is cutoff wavelength, MFD and ZDW, and not of just one parameter as in above US patent or of just two parameters as in above Japanese patent, is required to have an optical fiber having all the three waveguide parameters and other fiber characteristics within the limits of desired ranges.

It has also been observed and will be clear from the following description that evaluation of all the three waveguide parameters does not make the process complicated. As stated hereinabove, the present invention aims at providing a method which will consider all the three said waveguide parameters to provide an optical fiber having these parameters and other characteristics within the desired ranges.

Further, the method taught by the above Japanese patent only selects the single mode optical fiber base material only based on “R” obtained by multiplication of the cutoff wavelength and the mode field diameter. This method does not teach how to achieve the required range of wave-guide parameters for all processing optical fiber performs. On the contrary, it only teaches how to select the optical fiber preforms from the obtained correlation of “R”. Further limitation of this method is that the “R” should satisfy three conditions—a) should be more than a minimum value, b) should be in the setting range of the cutoff wavelength permitted by the single mode optical fiber base material and the diameter of the mode field, and c) the bending loss property of the optical fiber should be below a predetermined value respectively to achieve an optical fiber having i) distributed properties within predetermined limits, and ii) cutoff wavelength and the diameter of the mode field within the predetermined limits, and iii) if condition ii) has been satisfied, only then the bending loss property will be within the predetermined limits, thereby making the application of this process very restricted.

The present invention is also intended to overcome above limitations of the methods taught by the US and the Japanese patents by providing a method wherein the overcladding or clad jacketing over the core rod based on the i) predetermined core diameter of the core rod, ii) the refractive index [RI] profile of core of the core rod and iii) the refractive index [RI] profile of clad of the core rod to achieve the waveguide parameters—a) cutoff wavelength, b) MFD and c) ZDW within the predetermined limits. It has been surprisingly observed that once these three waveguide parameters are achieved within the predetermined limits, the other properties or characteristics of the optical fiber produced by the method of the present invention are also within the predetermined limits, thereby making the present method more widely applicable.

### NEED OF THE INVENTION

Therefore, there is a need to provide a method for producing optical fiber having desired waveguide parameters, such as cutoff wavelength, MFD and ZDW, and the other properties or characteristics within the predetermined limits just based on the determination and analysis of i) the refractive index [RI] profile of core of the core rod and ii) the refractive index [RI] profile of clad of the core rod, which are not only easy to be analysed even during the process for manufacturing the optical fiber, but also even when the actual refractive index [RI] profile has various configurations, and can still overcome some or all the limitations and drawbacks of the prior art discussed hereinabove.

### OBJECTS OF THE INVENTION

The main object of the present invention is to provide a method for producing optical fiber having desired waveguide parameters, such as cutoff wavelength, MFD and ZDW, and the other properties or characteristics within the predetermined limits just based on the determination and analysis of i) the refractive index [RI] profile of the core of the core rod and ii) the refractive index [RI] profile of the clad of the core rod.

The another object of this invention is to provide a method for producing the optical fiber wherein the above determination and analysis are carried out during its process for manufacturing, that is at the preform stage to avoid wastage of the base material and end product.

Still another object of this invention is to provide a method which can also overcome the limitations and drawbacks of the prior art discussed hereinabove.

Yet another object of this invention is to provide a method wherein the overcladding/clad jacketing over the core rod based on the i) predetermined core diameter of the core rod, ii) the refractive index [RI] profile of core of the core rod and iii) the refractive index [RI] profile of clad of the core rod.

This is an object of the present invention to provide a method which is more widely applicable and can be easily performed on-line during the manufacturing of the fiber to result in a fiber having desired parameters and characteristics within the predetermined limits.

This is another object of the present invention to provide an optical fiber having cutoff wavelength within a range varying from about 1160 nm to about 1300 nm, preferably from about 1200 nm to about 1300 nm, the mode field diameter [MFD] within a range varying from about 8.9 to about 9.5 μm, preferably from about 9 to about 9.4 μm and the zero dispersion wavelength [ZDW] within a range varying from about 1305 to about 1325 nm, preferably from about 1308 to about 1318 nm.

This is yet an object of the present invention to provide a method which will consider and control cutoff wavelength, MFD and ZDW to have these waveguide parameters within the predetermined limits in-addition to other characteristics of the fiber produced.

The other objects, advantages and preferred embodiments of the present invention will become more apparent from the following description when read in conjunction with the accompanying drawings, which are not intended to restrict scope of the present invention, but are incorporated for illustration of preferred embodiments of the present invention.

### BRIEF DESCRIPTION OF THE INVENTION

The optical fiber preform produced by conventional methods is observed to have fluctuations in the refractive index profiles due to some process conditioning. The optical fiber manufactured from such optical fiber preform which has fluctuations in the refractive index profiles of the core and clad from nominal values, will have the waveguide parameters out of the required range. This problem may be partially avoided by scrapping the fiber which results in increase in manufacturing cost of the fiber and making the process uneconomical.

In an ideal optical fiber, the typical waveguide parameters of the fiber are required to be lower with minimum variations from fiber to fiber. The properties of the fiber like microbending loss, splicing loss etc. will increase when the waveguide parameters are out of required or say allowed range. The splicing loss of fibers will become large when the variations in the mode field diameter [MFD] of fibers are large. The macrobending loss will increase when the cutoff wavelength of the fiber is on lower side of the required range and when the cutoff wavelength length is greater than higher side of the required range it will lead to transmit fewer mode rays which is not desirable for single mode fiber.

Therefore, a method is required which can result in the fiber having waveguide parameters within the limits of the predetermined range and have minimum variations from fiber to fiber to have wider applications.

Accordingly, there is provided a method for producing an optical fiber having desired waveguide parameters—cutoff wavelength, mode field diameter [MFD] and zero dispersion wavelength [ZDW], and other properties or characteristics of the fiber within the predetermined limits even when actual refractive index [RI] profile has various configurations, characterized by overcladding/clad jacketing over the core rod based on the i) predetermined core diameter of the core rod, ii) the refractive index [RI] profile of core of the core rod and iii) the refractive index [RI] profile of clad of the core rod to achieve said waveguide parameters within the predetermined limits.

In accordance with the present invention, the method for producing the optical fiber having desired waveguide parameters and other properties or characteristics within the predetermined limits comprises following steps:—
a) producing optical fiber core rod;
b) subjected the optical fiber core rod produced in step-a) for on-line analysis of refractive index [RI] profiles of core and clad of the core rod;
c) determining the A, which is the ratio of refractive index [RI] difference between refractive index of core and clad of the core rod, and refractive index [RI] of the core of the core rod;
d) determining the desired core diameter of fiber from the A obtained in step-c);
e) overcladding/clad jacketing over the core rod to form the optical fiber preform to have the desired core diameter of fiber obtained in step-d);
f) subjecting the optical fiber preform produced in step-e) to produce the optical fiber having desired core diameter obtained in step-d) thereby resulting in the optical fiber having desired waveguide parameters within predetermined limits.

The other preferred embodiments and advantages of the present invention will become more apparent from the reading of following description when read inconjuction with the accompanying drawings, which are not intended to limit scope of the present invention.

### BRIEF DESCRIPTION OF THE ACCOMPANYING DRAWING

FIG. 1 is a schematic representation of method of soot over cladding of a target rod with end burners to form an optical fiber preform.

FIG. 2 is the cross sectional view of the optical fiber.

FIG. 3 is graphical representation of cutoff wavelength range of the optical fiber showing its dependency upon the refractive index profiles of core and clad of the core rod and the core diameter of the fiber in accordance with the present invention.

FIG. 4 is graphical representation of mode field diameter (MFD) of the optical fiber showing its dependency upon the core diameter of the fiber, and the refractive index profiles of core and clad of the core rod in accordance with the present invention.

FIG. 5 is graphical representation of zero dispersion wavelength (ZDW) range of the optical fiber showing its dependency upon the core diameter of the fiber and the refractive index profiles of core and clad of the core rod in accordance with the present invention.

### DETAILED DESCRIPTION OF THE INVENTION

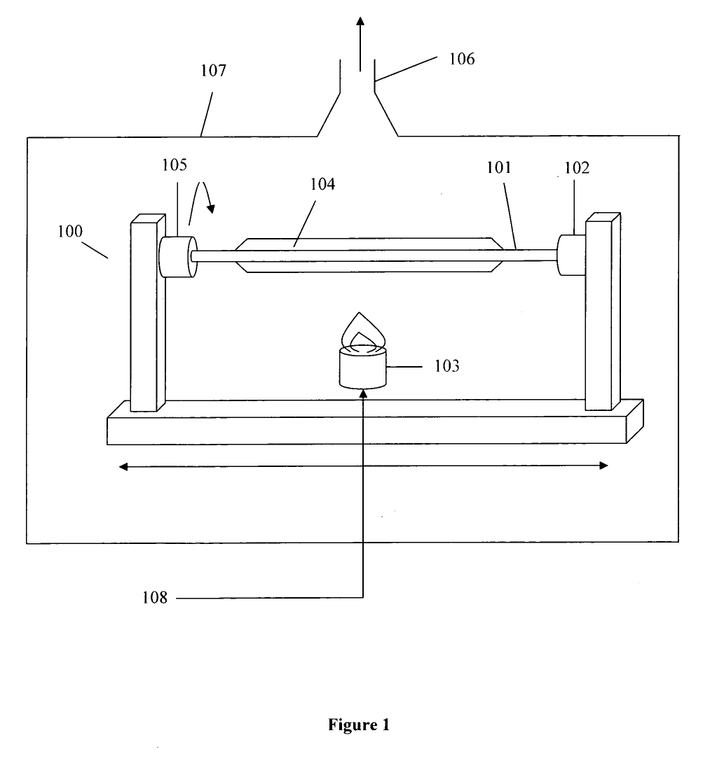

Now referring to FIG. 1, the core rod 101 is mounted on a glass-working lathe 100 between the chucks 102 and 105 over a plurality of soot depositing burners 103, preferably two burners, placed at close proximity to each other in a direction transverse to the length of the core rod (hereinafter referred to as the burner). The core rod can be fabricated by using any of the well-known methods to a person skilled in this art. For example, any of the known methods, such as Modified Chemical Vapor Deposition (MCVD), Outer Vapor Deposition (OVD), Vapor Axial Deposition (VAD) may be adopted.

Overcladding/clad jacketing over the core rod can be fabricated by suing any of the known methods such as soot over cladding called OVD, VAD and clad jacketing called sleeving process. The present invention is explained about overcladding/clad jacketing for example using OVD process for overcladding, however the other methods can also be applied for the present invention. The glass-working lathe 100 is enclosed inside the gas cabinet 107 as shown in FIG. 1. Both ends of the core rod are attached with handle rods in order to help mounting the core rod between the chucks 102 and 105. An exhaust duct 106 is provided in the gas cabinet 107 in order to remove un-deposited soot and unused reactant gas. The core rod rotates about its longitudinal axis with a rotational speed, preferably above 60 rpm. The core rod 101 traverses along the longitudinal direction over the burner 103 whereas the burner is kept stationary. During the traverse passes, SiCI₄ vapour is supplied from the burner along with oxyhydrogen fuel from the delivery line 108 so that SiCl₄ reacts with O₂ to form soot particles for deposition on the core rod 101, resulting into a soot porous body 104 deposited on the core rod 101.

In accordance with the present invention, the method for producing an optical fiber having desired waveguide parameters—cutoff wavelength, mode field diameter [MFD] and zero dispersion wavelength [ZDW], and other properties or characteristics of the fiber within the predetermined limits even when actual refractive index [RI] profile has various configurations is characterized by overcladding/clad jacketing on the core rod 101 based on the i) predetermined core diameter of the core rod, ii) the refractive index [RI] profile of core of the core rod and iii) the refractive index [RI] profile of clad of the core rod to achieve said waveguide parameters within the predetermined limits.

In accordance with this invention, the method for producing the optical fiber having desired waveguide parameters and other properties or characteristics within the predetermined limits comprises following steps:—
a) producing optical fiber core rod;
b) subjected the optical fiber core rod produced in step-a) for on-line analysis of refractive index [RI] profiles of core and clad of the core rod;
c) determining the Δ, which is the ratio of refractive index [RI] difference between refractive index of core and clad of the core rod, and refractive index [RI] of the core of the core rod;
d) determining the desired core diameter of fiber from the Δ obtained in step-c);
e) overcladding/clad jacketing over the core rod to form the optical fiber preform to have the desired core diameter of fiber obtained in step-d);
f) subjecting the optical fiber preform produced in step-e) to produce the optical fiber having the desired diameter obtained in step-d) thereby resulting in the optical fiber having desired waveguide parameters within predetermined limits.

The deposition process in above step-e) is continued till the desired core diameter is achieved. The deposited soot porous body is then moved into a sintering furnace, where the deposited porous soot layer is dried and consolidated in a chlorine and helium atmosphere to form a solid glass optical fiber preform at about 1500° C.

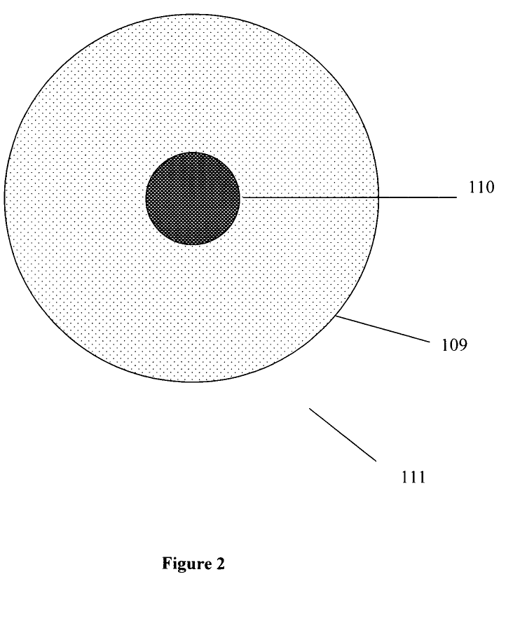

The optical fiber 111 is drawn from the optical fiber preform produced by the present method by using drawing furnace. As shown in FIG. 2, the optical fiber 111 comprises core 110 surrounded by clad 109 in which the clad 109 diameter of the fiber is approximately 125 μm and the core 110 diameter is approximately 8-9 μm.

The on-line analysis of refractive index [RI] profiles of core and clad of the core rod in above step-b) can be carried out by any know means. For example, the core rod is loaded on the chuck of the profiler analyzer to measure the refractive index of the core n1 and refractive index of clad n2 of the core rod. The profiler analyzer basically consists of tank with index matching liquid into which the core rod is immerse, an optical unit that has a laser with typically 632.8 nm wavelength and detector. As the measurement starts, the laser beam scans the entire radial direction of the core rod. Due to change in RI in core rod, the light is deflected and deflected angle is measured by the detector. The deflection units are expressed in radians. The deflection data is reconstructed into refractive index [RI] profiles by using a reconstruction algorithm with 5-micron step size.

The A, which is the ratio of refractive index [RI] difference between refractive index of core and clad of the core rod, and refractive index [RI] of the core of the core rod is determined by following equation 2:—

Δ=n₁²−n₂²/2n₁² equation (2)

wherein
Δ is ratio of refractive index [RI] difference between refractive index of core and clad of the core rod, and refractive index [RI] of the core of the core rod
n₁ is refractive index of core of the core rod
n₂ is refractive index of clad of the core rod

In order to achieve the predetermined cutoff wavelength, MFD and ZDW waveguide parameters of the fiber to be produced from the optical fiber preform produced, the core diameter of the fiber, which herein is referred as “desired core diameter” of the fiber is controlled based on following equations 3:—

Core dia (d)=(d1+d2+d3)/K eqn (3)

wherein
K is the constant and is set to be varying between about 2.8 to about 3.2,
d1, d2 and d3 are referred as “core diameters” of the fiber when considering the cutoff wavelength, MFD and ZDW respectively.

The “core diameter” d1 when considering the cutoff wavelength is determined by following equation 4:—

Core dia (d1)=(required cutoff+578−80.5Δ−0.285L)/126 eqn (4)

The above equation 4 is derived from following equation 5 which shows the relationship between optical property—cutoff wavelength and core rod parameters:—

Cutoff=−578+126d1+80.5Δ+0.285L equation (5)

In eqns. 4 and 5
Cutoff is the cutoff wavelength of the optical fiber
d1 is the core diameter of the optical fiber
Δ is the ratio of refractive index difference between refractive index of core and clad, and refractive index of the core of the core rod
L is the deposition length

TABLE 1

| Predictor | Coef | SE Coef | T | P |
|---|---|---|---|---|
| Constant | −429.0 | 167.2 | −2.57 | 0.011 |
| Δ | 97.004 | 8.446 | 11.48 | 0.000 |
| d1 | 109.30 | 16.56 | 6.60 | 0.000 |

S = 21.18
R² = 58.3%

The above equations 4 and 5 indicate that the cutoff wavelength of the fiber is more dependent upon the core diameter of fiber (d1), and the refractive index ratio (Δ) and Table (1) shows that the correlation coefficient R² is 58.3% between cutoff wavelength, and core diameter (d1) and refractive index profile (Δ), and the correlation coefficient R² is obtained by the regression analysis tool.

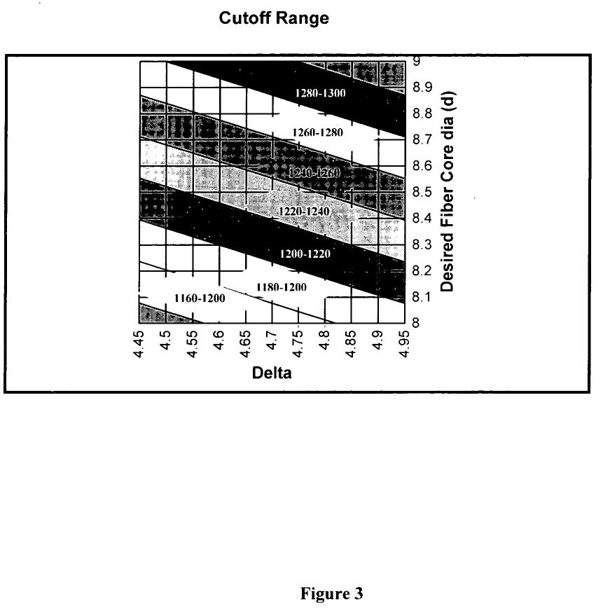

The dependency of cutoff wavelength range of the optical fiber on the refractive index profiles of core and clad of the core rod, that is on the refractive index ratio (Δ) and the core diameter is shown in accompanying FIG. 3 which illustrates the same by way of graphical representation in accordance with the present invention.

The “core diameter” d2 when considering MFD is determined by following equation 6:—

Core dia (d2)=(required MFD+0.383Δ−7.38)/0.438 eqn (6)

The above equation 6 is derived from following equation 7 which shows the relationship between optical property—MFD and core rod parameters:—

MFD=7.38+0.438d2−0.383Δ Equation (7)

In eqns. 6 and 7
MFD is mode field diameter of the optical fiber
d2 is the core diameter of the optical fiber
Δ is the ratio of refractive index difference between refractive index of core and clad, and refractive index of the core of the core rod

TABLE 2

| Predictor | Coef | SE Coef | T | P |
|---|---|---|---|---|
| Constant | 7.3760 | 0.4203 | 17.55 | 0.000 |
| d2 | 0.43759 | 0.04608 | 9.50 | 0.000 |
| Δ | −0.38263 | 0.03169 | −12.07 | 0.000 |

S = 0.05760
R² = 69.7%

The above equations 6 and 7 indicate that the MFD of the fiber is proportional to the core diameter of fiber (d2), and inversely proportional to the refractive index ratio (Δ) and Table (2) shows that the correlation coefficient R² is 69.7% between MFD, and core diameter (d2) and refractive index profile (Δ), and the correlation coefficient R² is obtained by the regression analysis tool.

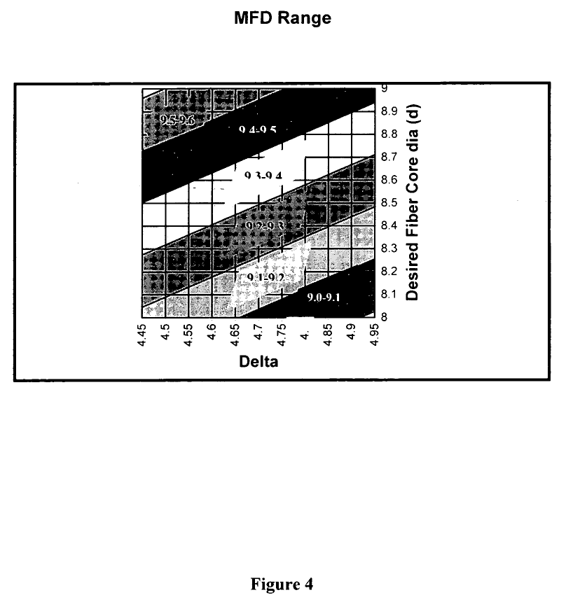

The dependency of MFD range of the optical fiber on the refractive index profiles of core and clad of the core rod, that is on the refractive index ratio (Δ) and the core diameter (d2) is shown in accompanying FIG. 4 which illustrates the same by way of graphical representation in accordance with the present invention.

The “core diameter” d3 when considering ZDW is determined by following equation 8:—

Core dia (d3)=(1486−required ZDW−7.73Δ)/15.5 eqn (8)

The above equation 8 is derived from following equation 9 which shows the relationship between optical property—ZDW and core rod parameters:—

ZDW=1486−15.5d−7.73Δ Equation (9)

In eqns. 8 and 9
ZDW is zero dispersion wavelength of the optical fiber
d3 is the core diameter of the optical fiber
Δis the ratio of refractive index difference between refractive index of core and clad, and refractive index of the core of the core rod

TABLE 3

| Predictor | Coef | SE Coef | T | P |
|---|---|---|---|---|
| Constant | 1485.91 | 15.23 | 97.53 | 0.000 |
| d3 | −15.533 | 1.670 | −9.30 | 0.000 |
| Δ | −7.725 | 1.149 | −6.73 | 0.000 |

S = 2.088
R² = 54.2%

The above equations 8 and 9 indicate that the ZDW of the fiber is inversely proportional to the core diameter of fiber (d3) and the refractive index ratio (Δ), and Table (3) shows that the correlation coefficient R2 is 54.2% between ZDW, and core diameter (d3) and refractive index profile (Δ), and the correlation coefficient R² is obtained by the regression analysis tool.

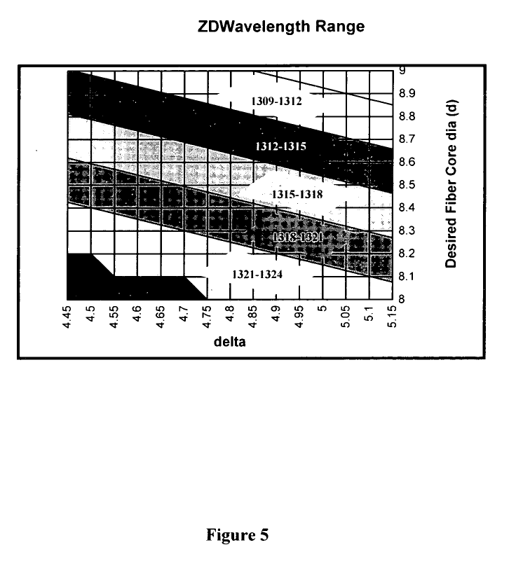

The dependency of ZDW range of the optical fiber on the refractive index profiles of core and clad of the core rod, that is on the refractive index ratio (Δ) and the core diameter (d3) is shown in accompanying FIG. 5 which illustrates the same by way of graphical representation in accordance with the present invention.

In one embodiment of this invention, the “desired core diameter (d)” of the fiber can also be referred as “d1” when it is only desired to reduce the standard deviation of cutoff wavelength, and similarly “d” can also be referred as “d2” when it is only desired to reduce the standard deviation of mode field diameter [MFD], and similarly, the desired core diameter “d” can also be referred as “d3” when it is only desired to reduce the standard deviation of zero dispersion wavelength [ZDW]. Such selection is adopted, when only waveguide parameter is required to be within the predetermined limits and other waveguide parameters may remain in the broader range.

Accordingly, in one of the preferred embodiments, the present invention provides a method for producing an optical fiber having one or more of desired waveguide parameters selected from group comprising cutoff wavelength, mode field diameter [MFD] and zero dispersion wavelength [ZDW] even when actual refractive index [RI] profile has various configurations, characterized by considering core diameter d1 when it is only desired to reduce standard deviation of cutoff wavelength, or core diameter d2 when it is only desired to reduce standard deviation of mode field diameter [MFD], or core diameter d3 when it is only desired to reduce the standard deviation of zero dispersion wavelength [ZDW].

In another embodiment of this invention, the desired core diameter “d” of the fiber can also be determined by following equation 10:—

Core dia (d)=d1+K′(d2−d1) eqn (10)

wherein K′ is constant and less than or equal to 1.

In above equation 10, when K′ is set to 1, the MFD standard deviation is suppressed and when K′ is set to 0, the cutoff wavelength deviation is suppressed. In order to suppress optimally in both waveguide parameters the K′ should be equal or less than 0.5. It may be noted that above equation 10 only takes cutoff wavelength and MFD waveguide parameters into consideration and not the third ZDW.

Accordingly, in another preferred embodiment the present invention provides a method for producing an optical fiber having desired waveguide parameters cutoff wavelength and mode field diameter [MFD] even when actual refractive index [RI] profile has various configurations, characterized by determining the desired core diameter “d” of fiber by following equation 10:

Core dia (d)=d1+K′(d2−d1) eqn (10)
wherein K′ is constant and less than or equal to 1;
d1 is core diameter when considering further reduction in standard deviation of cutoff wavelength; and
d2 is core diameter when considering further reduction in standard deviation of mode field diameter [MFD].

Therefore, the scope of the present invention is not restricted only to consideration and selection of above referred three waveguide parameters, but in the preferred embodiments, one may also choose to select either any one or two of the three waveguide parameters. However, as described hereinabove, under such circumstances, the non-selected and non-considered waveguide parameter may not be within the predetermined limits.

Accordingly, in one preferred embodiment of this invention, the desired diameter (d1) is reduced when the refractive index of core of the core rod is higher than the nominal value by using above equation 4 thereby achieving the desired cutoff wavelength and reducing the standard deviation of the desired cutoff wavelength.

In another preferred embodiment of this invention, when only the MFD is required to be within the predetermined limits and it is desired to improve its standard deviation, the desired diameter (d2) is increased when the refractive index of core of the prefrom is higher than the nominal value by using equation (6) thereby achieving the desired value of MFD and reducing its standard deviation.

In still another preferred embodiment of this invention, when only the ZDW is required to be within the predetermined limits and it is desired to improve its standard deviation, the desired diameter (d3) is reduced when the refractive index of core of the preform is higher than the nominal value by using above equation (8) thereby achieving the desired value of ZDW and reducing its standard deviation.

After determining the refractive index ratio (Δ) and the desired core diameter (d) of the core rod, the optical fiber preform is produced by soot overcladding in above step-e) while continuing the soot deposition till to have the desired core diameter of fiber. The optical fiber preform produced in above step-f) is then subjected to produce the optical fiber having the desired core diameter.

The optical fiber produced in accordance with the present invention was observed to have desired waveguide parameters within the predetermined limits, that is the cutoff wavelength was observed to be within a range varying from about 1160 nm to about 1300 nm, the mode field diameter [MFD] was observed to be within a range varying from about 8.9 to about 9.5 μm and the zero dispersion wavelength [ZDW] was observed to be within a range varying from about 1305 to about 1325 nm.

In one of the preferred embodiments of this invention, the optical fiber produced in accordance with the present invention was observed to have desired waveguide parameters within further narrower predetermined limits, that is the cutoff wavelength was observed to be within a range varying from about 1200 nm to about 1300 nm, the mode field diameter [MFD] was observed to be within a range varying from about 9 to about 9.4 μm and the zero dispersion wavelength [ZDW] was observed to be within a range varying from about 1308 to about 1318 nm.

It may be noted that the above description makes it clear that the present method for producing optical fiber having desired waveguide parameters, such as cutoff wavelength, MFD and ZDW, and the other properties or characteristics within the predetermined limits is just based on the determination and analysis of i) the refractive index [RI] profile of the core of the core rod and ii) the refractive index [RI] profile of the clad of the core rod. Once the refractive profiles of the core and the clad of the core rod are measured and analyzed by the profile analyzer for example PK bench 2600 to obtain the refractive index ratio (Δ), the desired core diameter (d) can be easily determined from either of the above equations 3, 4, 6, 8 or 10 depending upon the selection of the desired one or more waveguide parameters while applying the desired value of the selected waveguide parameter.

It is now also clear from the forgoing description that the present method can be performed during the process for production of the optical fiber, that is as on-line process, that is at the preform stage to avoid wastage of the base material and end product.

As the present method only involves determination and analysis of refractive index profiles of the core and clad of the optical fiber preform, which can be easily determined and analyzed with the help of profile analyzer, it also overcomes the limitations and drawbacks of the prior art.

The above description draws reference to the soot deposition, which may be interpreted in the broadest possible meaning and to include formation of the fiber preform by any known method, because the scope of the present invention is not restricted by selection of method for producing the optical fiber preform.

It has been further observed that the optical fiber drawn from optical fiber preform produced according to the present invention has well-controlled waveguide parameters and also the reduced standard deviation of waveguide parameters. The additional advantage of the present invention is that the yield loss in core rod fabrication is reduced due to consideration of the refractive index ratio (Δ).

As the present method can be performed even if one or more of the selected waveguide parameters are required to be within the predetermined limits, it has been found to be more widely applicable for producing the optical fiber having any desired combination of the waveguide parameters in-addition to other properties or characteristics of the fiber produced. This and other above features of the present invention will become more apparent from the following examples, which are not intended to limit the scope of the present invention.

### EXAMPLES

### Example 1

A set of 10 optical fiber preforms (A) is manufactured in accordance with the conventional method and another set of 10 optical fiber preforms (B) is manufactured in accordance with the method of the present invention while growing the soot till to have the desired diameter of fiber, determined based on above equation 3. The fibers manufactured from the above performs are measured for their cutoff wavelength, MFD and ZDW waveguide parameters and the results thereof are shown in following Table 4 with their mean, median and standard deviation.

TABLE 4

| | | CUT OFF | MFD | ZDW |
|---|---|---|---|---|
| Set (A) | Mean | 1215 | 9.267 | 1317 |
| | Median | 1211 | 9.274 | 1317 |
| | Std Dev | 35 | 0.16 | 2.86 |
| Set (B) | Mean | 1240 | 9.3 | 1313 |
| | Median | 1241 | 9.31 | 1313 |
| | Std Dev | 20 | 0.107 | 1.836 |

### Example 2

A set of 10 optical fiber preforms (C) is manufactured in accordance with the method of the present invention while growing the soot till to have the desired diameter of fiber, determined based on above equation 4. In this case the cutoff wavelength is desired to be 1250 nm. The fibers manufactured from the above performs (C) are measured for their cutoff wavelength, MFD and ZDW waveguide parameters and the results thereof are shown in following Table 5 with their mean, median and standard deviation. These results show that the cutoff wavelength achieved is very close to the desired value of the cutoff wavelength of 1250 nm and the standard deviation [Std Dev] of the cutoff wavelength is further reduced, but it results in increase is the standard deviations of other two waveguide parameters, that is of MFD and ZDW when compared with results given in Table 4.

TABLE 5

| | | CUT OFF | MFD | ZDW |
|---|---|---|---|---|
| Set (C) | Mean | 1253 | 9.34 | 1311 |
| | Median | 1248 | 9.30 | 1311 |
| | Std Dev | 16 | 0.127 | 1.96 |

### Example 3

A set of 10 optical fiber preforms (D) is manufactured in accordance with the method of the present invention while growing the soot till to have the desired diameter of fiber, determined based on above equation 6. In this case the mode field meter [MFD] is desired to be 9.2 μm. The fibers manufactured from the performs (D) are measured for their cutoff wavelength, MFD and ZDW waveguide parameters and the results thereof are shown in following Table 6 with their mean, median and standard deviation. These results show that MFD achieved is very close to the desired value of the MFD of 9.2 μm and the standard deviation [Std Dev] of the MFD is further reduced, but it results in increase in standard deviations of other two waveguide parameters, that is of cutoff wavelength and ZDW when compared with results given in Table 4.

TABLE 6

| | | CUT OFF | MFD | ZDW |
|---|---|---|---|---|
| Set (D) | Mean | 1223 | 9.23 | 1312 |
| | Median | 1220 | 9.21 | 1312 |
| | Std Dev | 22 | 0.085 | 1.99 |

### Example 4

A set of 10 optical fiber preforms (E) is manufactured in accordance with the method of the present invention while growing the soot till to have the desired diameter of fiber, determined based on above equation 8. In this case the zero dispersion wavelength [ZDW] is desired to be 1315 nm. The fibers manufactured from the performs (E) are measured for their cutoff wavelength, MFD and ZDW waveguide parameters and the results thereof are shown in following Table 7 with their mean, median and standard deviation. These results show that ZDW achieved is very close to the desired value of the ZDW of 1315 nm and the standard deviation [Std Dev] of the ZDW is further reduced, but it results in increase in standard deviations of other two waveguide parameters, that is of cutoff wavelength and MFD when compared with results given in Table 4.

TABLE 7

| | | CUT OFF | MFD | ZDW |
|---|---|---|---|---|
| Set (E) | Mean | 1215 | 9.32 | 1314 |
| | Median | 1217 | 9.33 | 1314 |
| | Std Dev | 21 | 0.115 | 1.70 |

### Example 5

A set of 10 optical fiber preforms (F) is manufactured in accordance with the method of the present invention while growing the soot till to have the desired diameter of fiber, determined based on above equation 10. In this case the cutoff wavelength is desired to be 1250 nm and the mode field diameter [MFD] is desired to be 9.2 μm. The fibers manufactured from the above performs (F) are measured for their cutoff wavelength, MFD and ZDW waveguide parameters and the results thereof are shown in following Table 8 with their mean, median and standard deviation. These results show that cutoff wavelength achieved is very close to the desired value of the cutoff wavelength [1250 nm] and the mode field diameter [MFD] achieved is also very close to the desired value of the MFD [9.2 μm], and the standard deviations [Std Dev] of the cutoff wavelength and the MFD are further reduced, but it results in increase in standard deviation of third waveguide parameter, that is of ZDW when compared with results given in Table 4.

TABLE 8

| | | CUT OFF | MFD | ZDW |
|---|---|---|---|---|
| Set (F) | Mean | 1242 | 9.22 | 1314 |
| | Median | 1244 | 9.21 | 1314 |
| | Std Dev | 18 | 0.101 | 2.03 |

The optical fibers produced in accordance with the present invention were subjected to above analysis to find out the values of the cutoff wavelength, MFD and ZDW, and other characteristics of the fiber produced. All the fibers produced have shown the desired parameters within the predetermined limits.

The above experiments confirm the surprising results of the present invention described hereinbefore.

The present invention has been described with the help of the accompanying drawings and the foregoing figures. It is obvious for the persons skilled in the art to modify the present method without deviating from the scope of the present invention, and such modifications are included in the scope of this invention.

1. A method as claimed in claim 2 wherein said desired waveguide parameters includes at least one of cutoff wavelength, mode field diameter [MFD] and zero dispersion wavelength [ZDW] even when actual refractive index [RI] profile has various configurations.

2. A method for producing the optical fiber having desired waveguide parameters within the predetermined limits comprising following steps:—
a) producing optical fiber core rod;
b) subjecting said optical fiber core rod produced in step-a) for on-line analysis of refractive index [RI] profiles of core and clad of the core rod;
c) determining the Δ, which is the ratio of refractive index [RI] difference between refractive index of core and clad of said core rod, and refractive index [RI] of the core of said core rod;
d) determining desired core diameter of fiber from said Δ obtained in step-c);
e) overcladding/clad jacketing over said core rod to form optical fiber preform to have said desired core diameter of fiber obtained in step-d); and
f) subjecting said optical fiber preform produced in step-e) to produce the optical fiber having desired core diameter obtained in step-d) thereby resulting in the optical fiber having desired waveguide parameters within predetermined limits.

3. A method as claimed in claim 2, wherein said Δ is determined by following equation 2:
Δ=n₁²−n₂²/2n₁² equation (2)
wherein n₁ is refractive index of core of the core rod; and n₂ is refractive index of clad of the core rod.

4. A method as claimed in claim 2, wherein said desired core diameter is controlled based on following equation 3:
Core dia (d)=(d1+d2+d3)/K eqn (3)
wherein
K is the constant and is set to be varying between about
2.8 to about 3.2;
d1, d2 and d3 are core diameters of the fiber when considering the cutoff wavelength, MFD and ZDW respectively.

5. A method as claimed in claim 4, wherein said core diameter d1 when considering the cutoff wavelength is determined by following equation 4:
Core dia (d1)=(required cutoff+578−80.5Δ×0.285L)/126 eqn (4).

6. A method as claimed in claim 4, wherein said core diameter d2 when considering MFD is determined by following equation 6:
Core dia (d2)=(required MFD+0.383Δ−7.38)/0.438 eqn (6).

7. A method as claimed in claim 4, wherein said core diameter d3 when considering ZDW is determined by following equation 8:
Core dia (d3)=(1486−required ZDW−7.73Δ)/15.5 eqn (8).

8. A method for producing an optical fiber having one or more of desired waveguide parameters selected from group comprising cutoff wavelength, mode field diameter [MFD] and zero dispersion wavelength [ZDW] even when actual refractive index [RI] profile has various configurations, characterized by considering core diameter d1 when it is only desired to reduce standard deviation of cutoff wavelength, or core diameter d2 when it is only desired to reduce standard deviation of mode field diameter [MFD], or core diameter d3 when it is only desired to reduce the standard deviation of zero dispersion wavelength [ZDW].

9. A method for producing an optical fiber having desired waveguide parameters cutoff wavelength and mode field diameter [MFD] even when actual refractive index [RI] profile has various configurations, characterized by determining the desired core diameter “d” of fiber by following equation 10:
Core dia (d)=d1+K″(d2−d1) eqn (10)
wherein K′ is constant and less than or equal to 1;
d1 is core diameter when considering further reduction in standard deviation of cutoff wavelength; and
d2 is core diameter when considering further reduction in standard deviation of mode field diameter [MFD].

10. (canceled)

11. An optical fiber as claimed in claim 15 having cutoff wavelength within a range varying from about 1160 nm to about 1300 nm, preferably from about 1200 nm to about 1300 nm.

12. An optical fiber as claimed in claim 15 having mode field diameter [MFD] within a range varying from about 8.9 to about 9.5 μm, preferably from about 9 to about 9.4 μm.

13. An optical fiber as claimed in claim 15 having zero dispersion wavelength [ZDW] within a range varying from about 1305 to about 1325 nm, preferably from about 1308 to about 1318 nm.

14. A method as claim in claim 2 wherein said overcladding/clad jacketing over the core rod is based on:—
i desired core diameter of the core rod;
ii refractive index [RI] profile of core of the core rod; and
iii refractive index [RI] profile of clad of the core rod to achieve said waveguide parameters within the predetermined limits.

15. An optical fiber as and when produced from said method of claim 2.
